(19) United States
(12) Patent Application Publication
(10) Pub. No.: US 2003/0009542 A1
(43) Pub. Date: Jan. 9, 2003

(54) Digital entertainment solution

(76) Inventors: Alpay O. Kasal, Brooklyn, NY (US); Martin P. Senn, Park City, UT (US); Wilford T. Lee, Orem, UT (US); Joshua L. Hamer, Park City, UT (US); Daniel Osorio, Park City, UT (US); Aaron W. Smith, Woods Cross, UT (US)

Correspondence Address: Brian C. Kunzler, 10 West 100 South, Suite 425, Salt Lake City, UT, 84101, US

(21) Appl. No.: 10/172,175

(22) Filed: Jun. 13, 2002

Related U.S. Application Data
(60) Provisional application No. 60/297,791, filed on Jun. 14, 2001.

(51) Int. Cl. G06F 15/177; H04N 7/173; G06F 15/16

(52) U.S. Cl. 709/222; 709/247; 725/100; 709/231

(57) ABSTRACT

A digital entertainment solution includes a system for treating digital content, transmitting the digital content over a network to a viewing station where the digital content is presented to a viewer. A network-booting set-top box built from computer desktop technologies supports gaming, web browsing, e-mail, music listening, movie viewing and the like. A scan converter within the set-top box converts monitor resolution images to formats used by standard television sets. A browser within the set-top box substitutes fonts optimized for television viewing for standard fonts designed for computer monitors. Multiple set-top boxes are combined in a network and isolated from data-only devices to ensure service quality and to prevent unauthorized copying of digital content. The reach of the network is extended with wireless segments that use a variety of mechanisms to ensure security and service quality. A treatment process removes unneeded information that consumes bandwidth and reduces the quality of standard compression techniques such as MPEG 4.

### BACKGROUND OF THE INVENTION

1. The Field of the Invention

The invention relates to devices, methods, and systems for providing digital entertainment. Specifically, the invention relates to devices, methods, and systems for providing digital entertainment using conventional television sets.

2. The Relevant Art

The appetite for improved entertainment appears to be limitless. Consumers desire better access to and the option to select from a wider variety of entertainment forms such as music, web browsing, movies, video games, and the like. Digital media offers the promise of delivering multiple media types to consumers on a common medium. Despite the interest, many obstacles to the implementation of such implementations remain. Among these obstacles are bandwidth, quality-of-service (QOS), cost, and obsolescence.

The history of set-top boxes provides insight into the issues related to deploying video-oriented entertainment systems. The earliest set-top boxes were cable television tuning boxes developed to be compatible with existing television sets and thereby reduce deployment costs. These devices simply converted a local cable TV provider's signal to a television compatible format and allowed channel tuning via remote control. Though contemporary generations of cable systems support digitally encoded signals, the proprietary closed nature of set-top boxes and systems has hindered development of new applications and systems.

Historically, the development of set-top boxes has relied on specialized development platforms, such as Liberate or Spyglass, as well as specialized operating systems, such as VxWorks™, that are designed to work with very specific hardware. Although, specialized platforms, operating systems, and hardware provide certain advantages such as real-time pre-emptive multi-tasking, the technology base available on these specialized systems is limited, requiring custom development of both additional hardware and software components in order to deploy a commercial system. The result is long development cycles and a slow emergence of enabling technologies, such as Web browsers and streaming media players, that are necessary for deployment of advanced applications and systems.

In particular, video-on-demand (VOD) services that offer a television-like viewing experience have been difficult to deploy within devices and systems. MPEG-2, a standard video format for video-on-demand applications, consumes up to 9 mbps—a large portion of the bandwidth available on a typical existing network. When multiple patrons of a VOD service view movies simultaneously, bandwidth bottlenecks are likely, resulting in a poor viewing experience. Upgrading a network to support the high video data rates, although helpful in reducing bottlenecks, is an expensive, disruptive, and time-consuming process.

Most VOD systems require hardware-based decoding chips within each set-top box in order to render video at the frame rates and image quality that consumers have come to expect. Hardware-based decoding chips are required due to the performance limitations and slow advancement of specialized development platforms and systems. Existing set-top boxes are typically not robust enough to render full-screen high quality video entirely in software. The reliance on specialized hardware decoding often requires that movies be encoded in a special way, eliminating the ability to make changes to a system as newer and better video technologies emerge.

Web browsing is a feature that consumers desire within digital entertainment systems. Existing set-top boxes often include out of date software or hardware modules resulting in a poor browsing experience when compared with desktop computers. The on-chip HTML interpreters that are commonly used in existing set-top boxes accurately decode only the simplest of web pages. For example, web pages containing tables, frames, or embedded technologies such as rich media and flash are often displayed improperly. The problem is exacerbated in that upgrading existing set-top boxes is a cumbersome and expensive process requiring firmware and/or processing modules to be upgraded by a service technician.

The ability to play video games is another feature that consumers desire within digital entertainment systems. The availability of video game titles on set-top boxes is extremely limited in that the specialized platforms do not conform to standard video game platforms.

What is needed is a digital entertainment solution based upon widely available and constantly improving desktop computing and networking technologies that is inexpensive to build, easy to update, and which offers a wide variety of digital entertainment forms such as viewing movies, listening to music, playing games and browsing web sites. Furthermore, what is needed is a solution that reduces bandwidth consumption and facilitates deployment within existing networks.

### OBJECTS AND BRIEF SUMMARY OF THE INVENTION

The apparatus of the present invention has been developed in response to the present state of the art, and in particular, in response to the problems and needs in the art that have not yet been fully solved by currently available digital entertainment means and methods. Accordingly, it is an overall object of the present invention to provide an improved apparatus, system, and method for providing multiple forms of digital entertainment.

To achieve the foregoing object, and in accordance with the invention as embodied and broadly described herein in the preferred embodiments, an improved system, method, and apparatus are presented for interactively streaming digital content to viewer stations. The improved apparatus, system, and method reduce the bandwidth necessary to render full-screen movies while maintaining high image quality. The present invention also facilitates dynamic updates of software components and applications that are used to stream and present the digital content.

In a first aspect of the invention, widely-available and constantly improving desktop computing and networking components are combined into a network booting set-top box that receives and renders digital media streams using monitor resolutions and converts the rendered images to television formats for display on a standard television set. The set-top box of the present invention also facilitates high quality gaming and web browsing while using a television set as the display device. For example, web browsing quality is maintained by substituting the standard fonts designed for computer monitors with fonts optimized for television sets.

In a second aspect of the invention, the network booting set-top box is included in a site installation along with a streaming network and a server facility. The streaming devices on a new or existing network are isolated from data-only devices to ensure service quality. A customized run-time image is distributed from the server facility to each set-top box during a power-up sequence to reduce system cost, increase security, and enable automatic updates of software components from a centralized location such as the server facility or a multi-site network operations center.

In a third aspect of the invention, wireless segments and access points are added to extend the reach of the streaming network. Various mechanisms such as Wireless Equivalent Protocol (WEP) and a TDMA-like overlay are deployed to ensure the quality, reliability and security of the wireless segments.

In a fourth aspect of the invention, a treatment process is used to prepare digital content for compression and formatting into standard formats such as MPEG 4. The treatment process reduces the bandwidth required to render near DVD quality full-screen video which in one embodiment is less than 900 kbps. In particular, the treatment process removes unneeded information such as “mosquitoes” that consume bandwidth with standard compression techniques while reducing image quality. The reduced bandwidth enables support for more devices including wireless devices on a network such as the aforementioned streaming network.

These and other objects, features, and advantages of the present invention will become more fully apparent from the following description and appended claims, or may be learned by the practice of the invention as set forth hereinafter.

### BRIEF DESCRIPTION OF THE DRAWINGS

In order that the manner in which the advantages and objects of the invention are obtained will be readily understood, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a schematic block diagram depicting one embodiment of a digital entertainment solution of the present invention;

FIG. 2 is a flow chart diagram depicting one embodiment of a digital entertainment method of the present invention;

FIG. 3 is a flow chart diagram depicting one embodiment of a digital content treatment method of the present invention;

FIG. 4 is a flow chart diagram depicting one embodiment of a digital content delivery method of the present invention;

FIG. 5 is a schematic block diagram depicting one embodiment of a set-top box of the present invention; and

FIG. 6 is a flow chart diagram depicting one embodiment of a digital content display method.

### DETAILED DESCRIPTION OF THE PREFERRED EMBODIMENTS

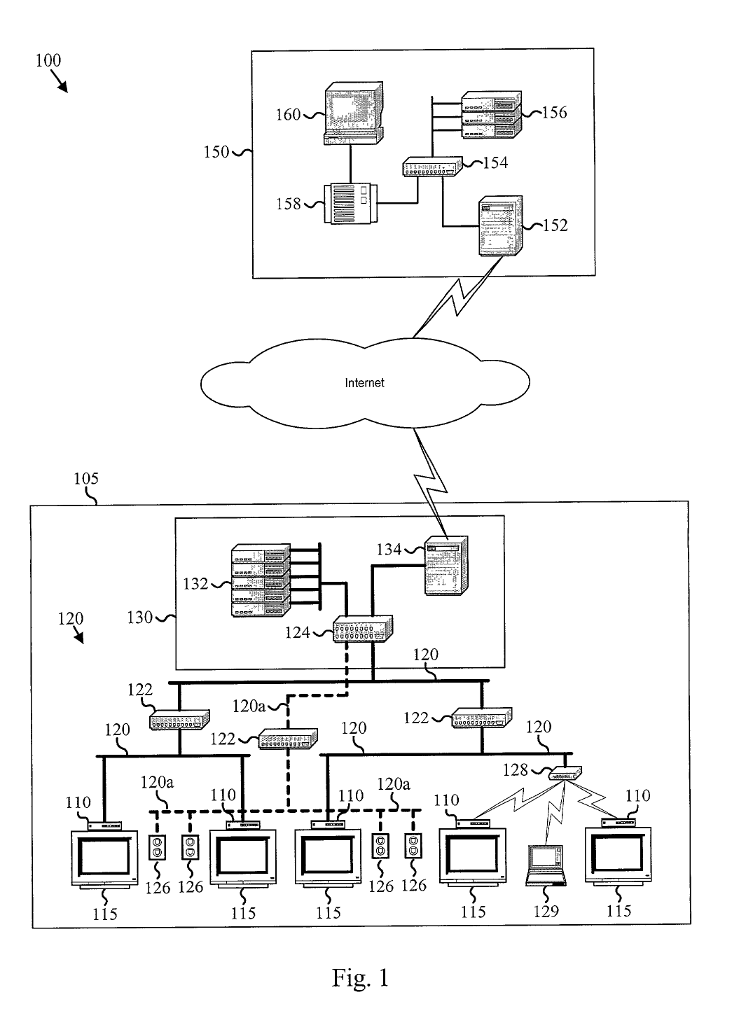

FIG. 1 is a block diagram depicting one embodiment of a digital entertainment solution 100 of the present invention. The digital entertainment solution 100 addresses many of the problems and issues inherent in the prior art as discussed in the Background Section above. The various subsystems of the digital entertainment solution 100 work together to prepare, deliver, and display digital content such as movies, games, web pages, and audio selections in a secure interactive manner to viewers via standard televisions.

The digital entertainment solution 100 includes a number of set-top boxes 110, coupled to television sets 115, a streaming network 120, and a server facility 130 in conjunction with an installation 105. The digital entertainment solution 100 also includes a network operations center (NOC) 150 that manages and communicates with multiple installations 105, preferably via secure means such as VPN connections.

The depicted NOC 150 includes a router 152, a switch 154, a server farm 156, and a 14 disk array 158. The disk array 158 archives media content for distribution to the installations 105. The NOC 150 and the server farm 156 host centralized services useful for managing and updating the installations 105.

In one embodiment, one of the servers within the server farm 156 is a run-time image management server (not shown) that contains master images of the operating system, applications, tools, and utilities that comprise the run-time images that are downloaded to and executed by the set-top boxes 110. A centralized image management server eases distribution of, and updates to, run-time images executed on the set-top boxes 110.

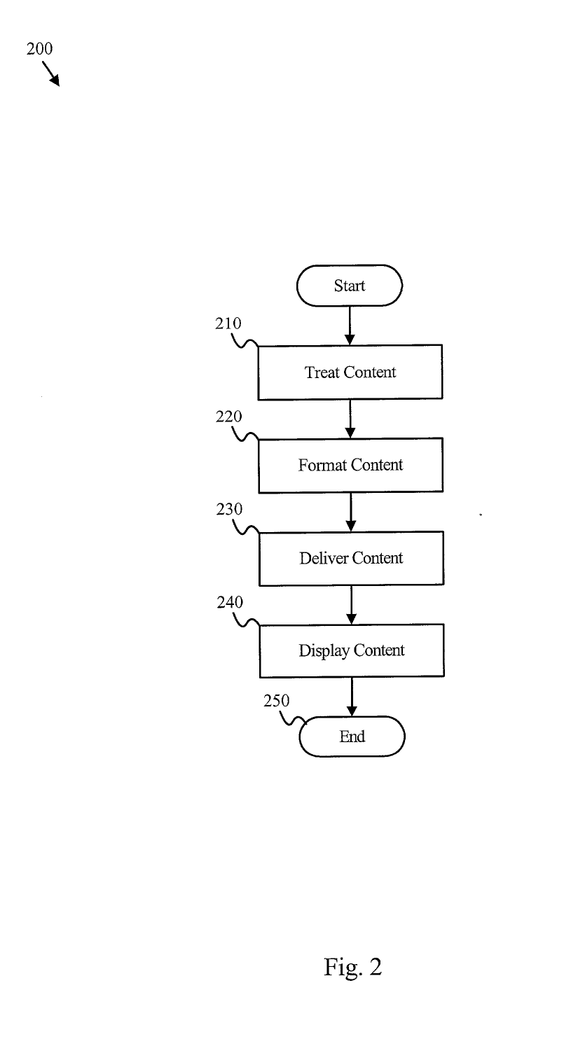

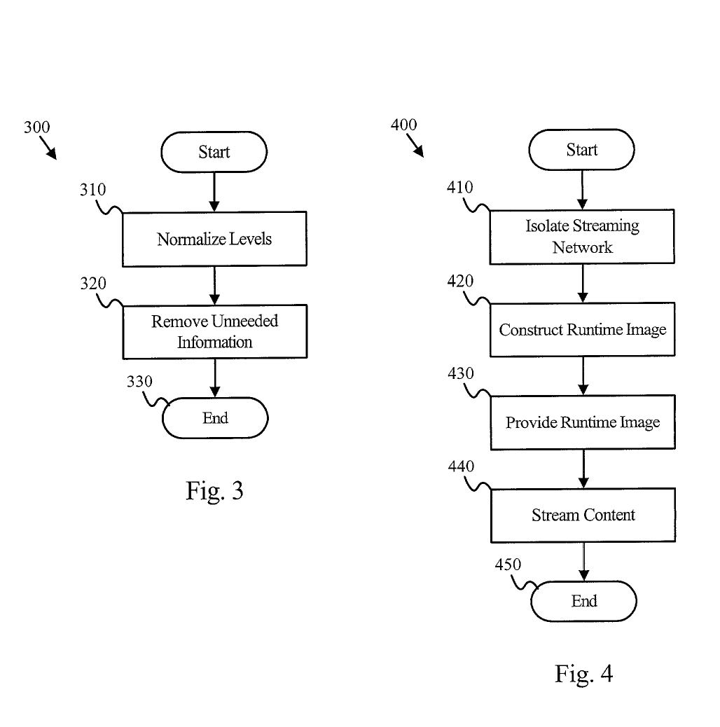

In conjunction with the digital entertainment solution 100, a treatment station 160 is used to prepare content for compression and distribution. A treatment process, which will be discussed below in more detail in conjunction with FIGS. 2 and 3, is conducted on the treatment station 160. The treatment process increases the effectiveness and quality of standard compression methods, such as MPEG 4 compression, to more than double compression ratios and achieve full-screen, near-DVD quality using less than 900 kbps of bandwidth. Although the treatment station 160 may be housed within the NOC 150, the treatment station may also be housed off-site, with a third party media preparation service, for example.

The streaming network 120 includes one or more edge switches 122 connected to a core switch 124. The edge switches 122 switch packets to and from data ports 126 and the set-top boxes 110. In one embodiment, the edge switches 122 reduce switching latency by conducting level 2 switching. The edge switches 122 also preferably provide media streams to the set-top boxes 110.

The streaming network 120 is engineered maintain a high quality of service by isolating data traffic, such as data transfers to and from the data ports 126, from the media streams carried on the streaming network 120. In one embodiment, isolation is achieved by wiring and physically isolating a separate data network 120a (shown with dashed instead of solid links within FIG. 1.) In another embodiment, data traffic is isolated by allocating virtual LANs within the streaming network 120 to provide a logical separation between streaming traffic and data traffic in addition to any physical separation.

The edge switches 122 and the core switch 124 are preferably interconnected with high speed links in a tree topology with the core switch at the root of the tree. In one embodiment, 100/FX links or gigabit fiber links are used to interconnect edge switches 122 and the core switch 124. In one embodiment, the core switch 124 is a hybrid layer 2 and layer 3 switch.

The core switch 124 typically resides in the server room 130 and provides high speed switching to and from the streaming network 120. In the depicted embodiment, the server room 130 also houses a server farm 132 and a router 134. Internet traffic intended for devices attached to the streaming network 120 is directed through the router 134. The router 134 preferably hosts a firewall to prevent external intrusion into the installation 105.

The server farm 132 includes a variety of servers that provide services to the streaming network 120. In one embodiment the server farm 132 includes a digital rights management server, a billing server, a database serve, a streaming media server, a web proxy server, and a run-time image server. In one embodiment, the various servers of the server farm 132 are connected into the streaming network 120 via gigabit fiber Ethernet links connected directly into 1000 fx ports on the core switch 124.

The digital rights management server within the server farm 132 preferably houses a commercially available digital rights management (DRM) system such as Microsoft's Digital Rights Manager. The available digital rights management system provides a first line of defense against piracy of copyrighted digital content thereby protecting entertainment providers against costly lawsuits. The available digital rights management system creates DRM protected files for distribution on the video-on-demand server. The DRM system also generates, distributes, and revokes licenses according to predefined specifications.

In response to clearance from the digital rights management system, the streaming media server provides both music and video content streams to television sets 115 via the streaming network 120 and the set-top boxes 110. The set-top boxes 110 receive the streamed digital content and convert the digital content to NTSC or PAL signals appropriate to the television sets 115.

The billing server within the server farm 132 handles billing activities and functions related to selections purchased by viewers. In one embodiment, the billing server includes a HOBIC interface that allows for direct integration into a property management system such as those found within hotels and retirement communities or it may include an HL7 interface that allows for direct integration into information systems found in the healthcare industry. Integration with a property management system facilitates integrated billing, reservation services, credit card and pre-paid clearing, and the like.

The database server within the server farm 132 houses a database. In one embodiment, the database contains billing information, billing rules, reporting rules, and indexed multimedia content. Storing indexed multimedia content within a database facilitates dynamic creation of custom screens containing currently available selections. Storing multimedia content in a searchable indexed manner also facilitates providing content search menus and services to aid viewers in the content selection process. In one embodiment, the database server also performs certain functions related to digital rights management that provide additional copyright protection above those provided by the digital rights management server.

The web proxy server within the server farm 132 preferably caches commonly requested web pages locally. In one embodiment, the web proxy server acts as a firewall, provides network address translation (NAT) functionality, conducts web content filtering, executes IP masquerading, and provides custom screens to the set-top boxes in the form of local web pages. The custom screens provided by the web proxy server may include, for example, an Intranet portal page that showcases local attractions, property amenities, local activities, and other services offered to viewers.

The run-time image server within the server farm 132 preferably receives run-time image updates from the run-time image management server within the NOC 150. The runtime image server builds a custom run-time image using custom settings such as those stored within the database on the database server. In one embodiment, a custom bootable run-time image is built in response to each run-time image update, the run-time image server hosts DHCP service, and a TFTP Service that are used to provide bootable run-time images to the set-top boxes 110 via the streaming network 120.

The streaming network 120 may also include wireless access points 128 that facilitate secure, high-speed, wireless communication to wireless set-top boxes 110 and other wireless devices 129 such as laptops and/or PDAs equipped with a wireless interface. Wireless access expands the reach of the streaming network 120 without requiring installation of additional wiring. In one embodiment, the wireless access points 128 and the set-top boxes 110 that are wireless support the IEEE 802.11a, 802.11b and 802.11g configurations and protocols. Quality of service (QOS) is maintained at a high level by restricting the number of wireless devices that use each wireless access point 128, for example by careful allocation of streaming channels, and by controlling antenna directionality of the access points.

Security on network segments is preferably maintained through a variety of means such as authentication of CPU serial number, Mac Address, and other hardware level identifiers. Furthermore, the wireless network segments are isolated with a predetermined Electronic Services Security ID (ESSID) and secured by 128 bit Wired Equivalent Privacy (WEP). In addition, a proprietary TDMA-like (Time Division Multiple Access) layer is installed on the wireless devices and isolates the streaming network 120 from any other wireless network interference. For example, if a hotel guest attempts to sniff the wireless network segments, standard 802.11 devices will not be able to communicate with the wireless access points 128 without installing the TDMA-like overlay. The TDMA-like solution also increases the QOS by time-division multiplexing the wireless bandwidth so that individual devices cannot saturate the network.

FIG. 2 is a flow chart diagram depicting one embodiment of a digital entertainment method 200 of the present invention. The digital entertainment method 200 may be conducted in conjunction with, or independent of, the digital entertainment solution 100. The digital entertainment method 200 is used to provide high-quality digital content including movies, music, games, and internet web pages in a secure, efficient manner.

The digital entertainment method 200 includes a treat content step 210, a format content step 220, a deliver content step 230, and a display content step 240. The treat content step 210 prepares the digital content for formatting and compression, and preferably prepares content in a manner that increases compression quality and performance of standard compression methods such as MPEG 4 compression.

In particular, the treat content step 210 reduces “mosquitoes” and other artifacts surrounding moving objects. The resulting compressed and formatted data is encoded at a low bit rate, which in one embodiment is less than 900 kbps. Despite the low bit rate, full screen movies may be played with little degradation and no dropped frames. One embodiment of the treat content step 210 will be discussed in more detail below in conjunction with FIG. 3.

The format content step 220 compresses and formats the treated content into a format suitable for streaming on the streaming network 120 and rendering on the set-top boxes 110—namely formats having monitor resolutions. The present invention formats, streams and renders at monitor resolutions in that the tools available for multimedia computing are less expensive, are more widely available, accommodate customization and progress faster than those associated with broadcasting. Using monitor resolutions rather than television or broadcast resolutions also facilitates seamless integration with games and web browsing—two highly desirable entertainment options.

In one embodiment, the treat content step 210 and the format content step 220 are conducted using a carefully selected, yet standard toolset that includes the Microsoft Windows Media Encoder, Adobe Premiere, Adobe After Effects, Eyeon Digital Fusion, AVIUTL, VirtualDub, VFAPI Reader, Matrox RT2500 and more. The aforementioned combination of tools along with “pre-processing” to remove unneeded information yields encoded video files that are superior in quality to the same video source encoded without the treat content step 210 and the format content step 220.

In a further embodiment, audio content is compressed and formatted to a 128 kbps MP3 format, and video is compressed and formatted to a 900 kbps or less MPEG 4 format featuring a 800×600 resolution. The formatted content is preferably stored within the disk array 158 within the NOC 150 to facilitate delivery to the installations 105.

The deliver content step 230 delivers the content from a centralized location such as the NOC 150 to locations such as the installations 105, where the content may be requested, accessed, and when appropriate, paid for by a viewer. Preferably, the digital content is securely streamed over a virtual private network (VPN) or other secure means to a media server or the like within the server farm 132. Thus, in one embodiment, the digital content is transmitted wholly within a closed system. From the server farm 132, the digital content may be requested by a viewer and streamed to the set-top boxes 110 via the streaming network 120. Content that is copyrighted is preferably only streamed to authorized devices, such set-top boxes 110 that have been authenticated.

The display content step 240 receives a digital content stream formatted for monitor resolutions and renders the digital content. For example, in one embodiment the set-top boxes 110 comprise one or more media players that render at an 800×600 resolution and a scan converter that converts the rendered 800×600 images to NTSC or PAL resolutions. Upon completion of streaming and rendering that is conducted in conjunction with the display content step 240, the digital entertainment method 200 ends 250.

FIG. 3 is a flow chart diagram depicting one embodiment of a digital content treatment method 300 of the present invention. The digital content treatment method 300 may be conducted as the treat content step 210 within the digital entertainment method 200. The digital content treatment method 300 improves the quality and performance of standard compression techniques such as MPEG 4 video compression. For example, video compression algorithms typically accomplish compression by finding redundancies and predictable motion within digitized video. The digital content treatment method 300 makes these attributes easier to detect using standard compression algorithms.

The digital content treatment method 300 includes a normalize levels step 310 and a remove unneeded information step 320. The normalize levels step 310 conducts operations that normalize the content to ranges optimized for rendering by the set-top boxes 110. In one embodiment the operations include chromatic adjustments, and normalization of IRE (luminance) levels. After the normalize levels step 310 the method proceeds to the remove unneeded information step 320.

The remove unneeded information step 320 removes information that degrades compression performance in terms of quality and bit-rate. For example, an image of a scene that is well-lit with a shadowy background may contain a lot of essential detail in the foreground along with noisy grayscale areas within the background. (Noisy backgrounds and shadows are inherent in most broadcast distribution formats, including high-end video formats like BetaSP and DigiBeta.) Standard video compression software does not know the difference between the essential foreground features and the rapidly moving noise or “mosquitoes” in the background shadows. By removing unneeded information precious compressed bandwidth may be dedicated to capture the detail of essential features.

In one embodiment, the remove unneeded information step 320 conducts selective softening and de-noising operations that reduces the number of shades within the content stream and smoothes the image in a perceptually acceptable manner. Upon completion of the remove unneeded information step 320, the digital content treatment method 300 ends 330.

FIG. 4 is a flow chart diagram depicting one embodiment of a digital content delivery method 400 of the present invention. The digital content delivery method 400 includes an isolate streaming network step 410, a construct run-time image step 420, a provide run-time image step 430, and a stream content step 440. The digital content delivery method 400 may be conducted independently of, or in conjunction with, the streaming network 120, the set-top boxes 110, and the digital entertainment method 200. The digital content delivery method 400 increases the reliability and security of streaming digital content and facilitates reliable software updates to the set-top boxes 110.

The isolate streaming network step 410 provides isolation for devices within a network that are authorized to interact with digital content streams from those that are not authorized to receive media streams, such as devices attached to the data ports 126. In one embodiment, the isolate streaming network step 410 comprises physical separation of network segments from streaming segments. In another embodiment, the isolate streaming network step 410 further comprises partitioning virtual LANs such that data-only devices may not interact with streaming devices.

The digital content delivery method 400 proceeds from the isolate streaming network step 410 to the construct run-time image step 420. The construct run-time image step 420 constructs a run-time image appropriate for execution on the set-top boxes 110. In one embodiment, the run-time image is a bootable run-time image that includes all the code necessary for a set-top box to boot and provide the desired entertainment services. In one embodiment, the run-time image is dynamically created from a database in response to image updates for various software components.

The digital content delivery method 400 proceeds from the construct run-time image step 420 to the provide run-time image step 430. The provide run-time image step 430 provides a run-time image upon request to a specific set-top box 110. In one embodiment, the provide run-time image step 430 provides a bootable run-time image in conjunction with a set-top box power-up sequence using the PXE and TFTP protocols.

Dynamic creation of the run-time image in a bootable form facilitates software distribution of updates. For example, when a new revision of a media player or Internet browser is released, the NOC 150 may distribute an image of the newly released software to a database on a run-time image server within the server farm 132. In turn, an updated customized run-time image may be constructed from the database of code images including custom menus, options, or web pages specified for the installation 105. Upon power-up or power recycling, the set-top boxes are automatically updated by performing a network boot resulting in the customized run-time image being downloaded to, and executed within, the set-top boxes 110.

In one embodiment, the dynamically created run-time image includes images from an embedded operating system, appropriate hardware drivers, various media players, an Internet browser, and a document reader. The run-time image is a preferably a “headless” image that excludes access to the operating system by a viewer.

The digital content delivery method 400 adds functionality, reliability, and value to the digital entertainment solution 100. For example, using a bootable run-time image reduces system costs in that the set-top boxes 110 need not have any permanent storage. This is particularly useful for property managers in that the set-top box 110 may be a “dumb” device that is useless if removed from its installation point. Copyright infringement is also prevented in that no persistent media exists from which copyrighted content may be retrieved.

Using a dynamically built run-time image also facilitates smaller executable footprints and reduced system cost in that the operating system and required applications may be stripped down to their bare essentials previous to distribution from the NOC 150. A scaled-down image is inherently more stable since there are less services running that can cause the system to crash. Removal of unneeded services and executables also limits exposure to unscrupulous applications and utilities such as viruses.

The digital content delivery method 400 proceeds from the provide run-time image step 430 to the stream content step 440. The stream content step 440 streams actual digital content, for example from a server within the server farm 132 to the set-top boxes via the streaming network 120. Upon completion of the stream content step 440, the digital content delivery method 400 ends 450.

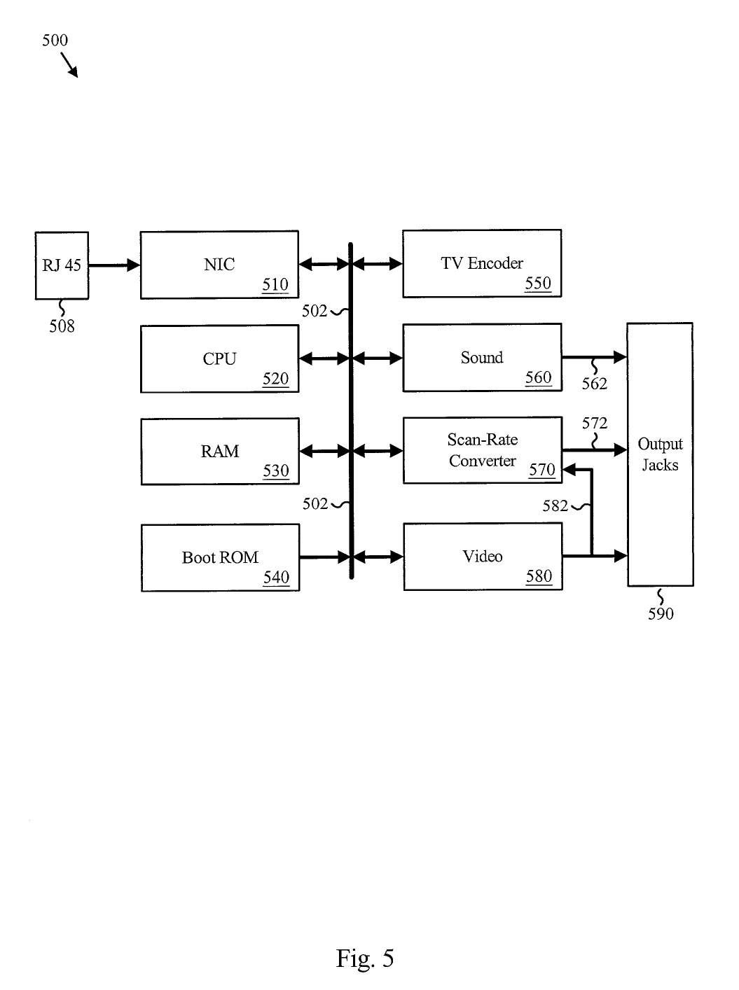

FIG. 5 is a block diagram depicting one embodiment of the set-top box 110 of the present invention. The depicted set-top box 110 includes a network interface 510, a CPU 520, a memory module 530, a boot ROM 540, a TV encoder 550, a sound module 560, a scan converter 570, and a video module 580. With the possible exception of the scan-rate converter, the components of the depicted set-top box 110 are preferably off the shelf commodity components that are low-cost and widely available.

The software executed on the depicted set-top box 110 is downloaded as a run-time image via a network connector 508 and the network interface 510 during a power-up sequence contained within the boot ROM 540. In the preferred embodiment, the network interface provides network booting capabilities such as PXE, thereby eliminating the need for a local hard disk drive or local flash disk. Preferably, the downloaded run-time image is a bootable run-time image containing the operating system and necessary applications to provide a complete digital entertainment suite to a viewer.

The focus of the software and hardware architecture of the set-top box 110 is on standard computer-oriented components that provide the latest multimedia features and services available on a commodity platform such as a desktop PC. The use of standard computer hardware enables use of contemporary games and software titles by a viewer. Using commodity components also hastens deployment, lowers system cost, and facilitates incorporation of the latest and most powerful components and revisions. This feature is particularly advantageous in keeping up with software updates within fast changing technologies such as Internet browsing and multimedia streaming.

Use of commodity computer-oriented components rather than television or broadcast components is enabled by the scan-rate converter 570. The scan-rate converter 570 receives a video signal 582 from the video interface 580 that is in a resolution and scan-rate common to computer monitors, such as 800×600. The scan-rate converter in turn provides a video signal 572 that is standard within television sets such as NTSC or PAL to the output jacks 590. In one embodiment, the video signal 582 is also provided to the output jacks to facilitate the use of an external monitor.

The software components contained within the bootable runtime image executed by the set-top box 110 are selected to provide quality gaming, Internet browsing, and movie viewing experiences. In one embodiment, the Internet browser contains a plug-in that substitutes fonts optimized for viewing on television sets in place of standard monitor-oriented fonts. In conjunction with anti-aliasing conducted within the scan converter 570, substituting fonts results in clear crisp images when viewing web pages and facilitates the use of intranet web pages to provide custom screens and menus on the set-top box 110.

In one embodiment, quality customs screens and web browsing are achieving by inclusion of Macromedia Shockwave, Microsoft ActiveX, Winbatch, Active Server Page (ASP) and SQL/ODBC (Standard Query Language and Open DataBase Connectivity) components along with selected custom utilities. The aforementioned combination of software applications and development tools enables automation of many functions that would have otherwise required additional user input to accomplish a given task. As an example of the power and versatility of the present invention, in one embodiment, a customizable screen provided by the present invention contains menu options and associated functionality for property services, movies and music, cable and TV, web and e-mail, games, and room service.

In one embodiment, the TV encoder 550 contains a broadcast tuner capable of receiving and decoding analog and digital television signals including enhanced television formats such as Intercast standardized by the Advanced Television Enhancement Forum. In one embodiment, the video module 580 comprises an nVidia™ chipset capable of a high refresh rate and a high video frame rate while lowering the processing burden on the CPU 520.

The set-top box 110 preferably includes interfaces to a wireless keyboard, pointing device, and remote control, all of which are omitted from the depicted set-top box 110 to simplify the illustration. Certain embodiments of the set-top box 110 may include an optional wireless network connection to facilitate communication with a wireless access point such as the wireless access point 128.

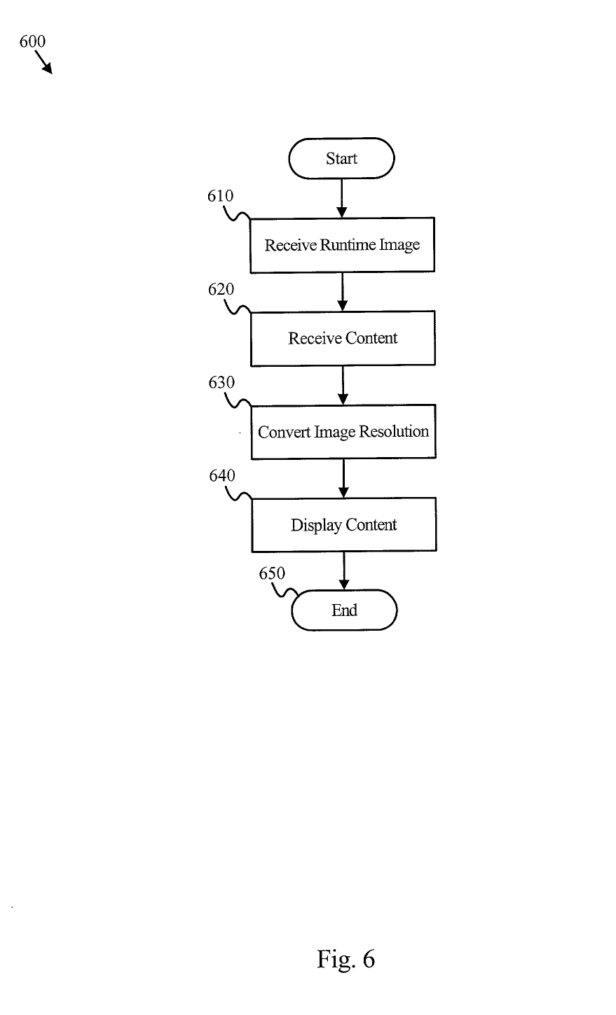

FIG. 6 is a flow chart diagram depicting one embodiment of a digital content display method 600. The digital content display method 600 includes a receive run-time image step 610, a receive content step 620, a convert image resolution step 630, and a display content step 640. The method may be conducted in conjunction with, or independent of the set-top box 110 and the streaming network 120. The digital content display method 600 is particularly useful when viewing content on television sets while using standard computer components to conduct content rendering.

The receive run-time image step 610 facilitates receiving a code image containing the desired (display) application for the current session. The receive run-time image step 610 is preferably conducted in conjunction with a power-up sequence in order to reduce the number of hardware and software components necessary to deploy an application. Once received, the run-time image is loaded and executed by the receiving system.

The digital content display method 600 proceeds from the receive run-time image step 610 to the receive content step 620. The receive content step 620 receives content formatted for display on standard computer hardware. In conjunction with the receive content step 620, the received content is render at the intended resolution. The receive content step 620 is followed by the convert image resolution step 630.

Since the intended resolution may not be the same as the actual displayed resolution, the convert image resolution step 630 is used to convert display-dependent components of the received content to a resolution suitable for display. Anti-aliasing is preferably conducted in conjunction with the convert image resolution step 630 in order to maintain high image quality. The method 600 proceeds to the display content step 640 to display the converted image at a resolution suitable for display. After the display content step 640, the method ends 650.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for providing digital content to viewers on demand, the system comprising:
a treatment station configured to receive digital content files and prepare the digital content files for transmission over a closed system network, including compressing the digital content files;
a network configured for transmitting the treated digital content files; and
a viewing station connected with the network for receiving the digital content files over the network and for displaying the digital content files to a user.

2. A system for interactively streaming digital content to a plurality of television sets, the system comprising:
a streaming network configured to stream digital content;
a plurality of set-top boxes configured to receive the digital content and convert the digital content from monitor resolutions to television resolutions; and
each set-top box of the plurality of set-top boxes further configured to boot from a bootable run-time image received on a communications port.

3. The system of claim 2, wherein the bootable run-time image is constructed on a locally accessible server using system settings that customize screens to be displayed by the plurality of set-top boxes.

4. The system of claim 2, wherein the bootable run-time image is constructed from a database comprising a plurality of code images.

5. The system of claim 4, wherein the bootable run-time image is constructed in response to updates to the database.

6. The system of claim 2, wherein the bootable run-time image includes a web browser configured to conduct font substitution.

7. The system of claim 6, wherein the web browser is configured to conduct font substitution using fonts optimized for television viewing.

8. The system of claim 2, wherein converting the digital content from monitor resolutions to television resolutions occurs using anti-aliasing filters.

9. The system of claim 2, wherein converting the digital content from monitor resolutions to television resolutions further comprises line doubling.

10. The system of claim 2, wherein the digital content comprises digital content in an MP3 audio format.

11. The system of claim 2, wherein the digital content comprises digital movies in an MPEG 4 format.

12. The system of claim 2, wherein the quality of the digital content is improved by pre-filtering the digital content previous to conducting MPEG 4 compression.

13. The system of claim 12, wherein pre-filtering removes color noise in background regions.

14. The system of claim 2, wherein the streaming network comprises wireless networking.

15. The system of claim 2, wherein the plurality of set-top boxes are capable of converting digital content comprising full screen movies at near DVD quality.

16. The system of claim 2, wherein the plurality of set-top boxes are further configured to receive and convert digital content comprising full-screen movies at near DVD quality using less than 900 kbps of network bandwidth.

17. The system of claim 2, wherein the plurality of set-top boxes are further configured to receive secure digital content.

18. The system of claim 2, wherein the streaming network is restricted to servicing set-top boxes.

19. The system of claim 2, further comprising at least one server configured to stream digital content to the streaming network.

20. The system of claim 2, further comprising at least one server configured to provide the bootable run-time image to the plurality of set-top boxes.

21. The system of claim 2, further comprising a router configured to provide Internet access to the set-top boxes.

22. The system of claim 2, further comprising a data network configured to provide networking services to a plurality of data ports.

23. The system of claim 22, further comprising at least one server configured to provide streaming content to the streaming network, and wherein devices attached to the data ports are blocked from accessing digital content on the at least one server.

24. The system of claim 22, wherein devices attached to the data ports are blocked from accessing data on the streaming network.

25. The system of claim 22, further comprising a router configured to provide Internet access to devices attached to the data network.

26. A method for interactively streaming digital content to a plurality of television sets, the method comprising:
pre-filtering digital content to reduce compression artifacts;
compressing the pre-filtered digital content to a streaming format;
providing a bootable run-time image to a set-top box; and
streaming the digital content to the set-top box.

27. The method of claim 26, wherein pre-filtering removes color noise within background regions.

28. The method of claim 26, further comprising constructing the bootable run-time image.

29. The method of claim 28, wherein constructing the bootable run-time image comprises constructing customized screens.

30. The method of claim 28, wherein the customized screens include custom menus.

31. The method of claim 28, wherein constructing the bootable run-time image comprises accessing a database comprising a plurality of code images.

32. The method of claim 31, wherein constructing the bootable run-time image occurs in response to updates to the database.

33. The method of claim 28, wherein constructing the bootable run-time image includes incorporating a web browser configured to conduct font substitution.

34. The method of claim 26, further comprising conducting font substitution.

35. The method of claim 34, wherein conducting font substitution is conducted using fonts optimized for television viewing.

36. The method of claim 26, further comprising converting images of web pages rendered at monitor resolutions to television resolution images.

37. The method of claim 26, further comprising anti-aliasing the digital content.

38. The method of claim 26, further comprising converting the digital content from monitor resolutions to television resolutions.

39. The method of claim 26, further comprising line-doubling.

40. The method of claim 26, wherein the streaming format is an MP3 audio format.

41. The method of claim 26, wherein the streaming format is an MPEG 4 video format.

42. The method of claim 26, wherein streaming the digital content comprises conducting wireless communications.

43. The method of claim 26, wherein streaming the digital content comprises full screen movies at near DVD quality.

44. The method of claim 43, wherein streaming is conducted using less than 900 kbps of bandwidth.

45. The method of claim 26, wherein streaming is conducted using secure streams.

46. An apparatus for rendering streamed digital content to a television, the apparatus comprising:
a tuner configured to receive and decode TV broadcasts;
a resolution converter configured to convert monitor resolution images to television resolution images;
a network interface configured to receive a bootable run-time image during a power-up sequence; and
a BIOS configured to boot the apparatus from the bootable run-time image.

47. The apparatus of claim 26, wherein the bootable run-time image includes a media player configured to render digital content streams at monitor resolutions.

48. The apparatus of claim 27, wherein the media player is configured to render MP3 audio streams.

49. The apparatus of claim 27, wherein the media player is configured to render MPEG 4 video streams.

50. The apparatus of claim 27, wherein the media player is configured to render digital streams comprising full-screen movies at near DVD quality using less than 900 kbps of bandwidth.

51. The apparatus of claim 26, wherein the bootable run-time image includes a web browser configured to conduct font substitution.

52. The apparatus of claim 31, wherein the web browser is configured to conduct font substitution using fonts optimized for television viewing.

53. The apparatus of claim 26, wherein the resolution converter comprises anti-aliasing filters.

54. The apparatus of claim 26, wherein the resolution converter further comprises line-doubling means.

55. The apparatus of claim 26, wherein the media player is further configured to receive secure digital streams.
